(19) United States
(12) Patent Application Publication
(10) Pub. No.: US 2015/0026271 A1
(43) Pub. Date: Jan. 22, 2015

(54) SYSTEM FOR EVENT NOTIFICATION AND INFORMATION POSTING

(71) Applicant: E-OBITUARY SDN BHD, Subang Jaya (MY)

(72) Inventors: Chee Chung CHEONG, Subang Jaya (MY); Kevin Boon Keng LEOW, Subang Jaya (MY); Hon Siang CHUNG, Cheras (MY)

(73) Assignee: E-OBITUARY SDN BHD, Subang Jaya (MY)

(21) Appl. No.: 14/183,085

(22) Filed: Feb. 18, 2014

Related U.S. Application Data
(63) Continuation of application No. 13/978,431.

(30) Foreign Application Priority Data
Jan. 7, 2011 (MY) PI 2011000091

(51) Int. Cl. H04L 12/58; G06F 17/30

(52) U.S. Cl. CPC H04L 51/046; G06F 17/30699
USPC 709/206; 707/754

(57) ABSTRACT

A system for event notification and information posting (1) comprises a data processing means (2) for receiving the information of an event and merging the event information with a notification, a transmitting means (3) for transmitting the notification to a receiver, a feedback processing means (4) for receiving a feedback from the receiver and filtering the contents of the feedback, a responding means (5) for responding to the feedback from the receiver, an information posting means (6) for posting and displaying the event notification and the feedback from the receiver at a displaying means, and a data storing means (7) for storing the event information, the notification, and the feedback. The system (1) further comprises a reminding means (8) for managing the dates and anniversaries of the event and for reminding the receiver the dates and anniversaries of the event.

This is a continuation application based upon U.S. patent application Ser. No. 13/978,431, filed Jul. 5, 2013, which is a National Stage of International Application No. PCT/MY2012/000002 filed Jan. 6, 2012, which claims the benefit of priority from Malaysian Patent Application No. PI 2011000091, filed on Jan. 7, 2011, the contents of all of which are incorporated herein by reference in their entirety.

### TECHNICAL FIELD OF THE INVENTION

This invention is related to a system for event notification and information posting.

### BACKGROUND OF THE INVENTION

Due to the advancement of technology in this present era, difficult tasks are easily completed using technologies that are created by intelligent human beings. Conventionally, when there is a need to host an event, the host of the event will eventually have to call each and every invitee of the event to notify them that the event will be held when and where, due to the fact that only phone communication was available in the past. In order to call each and every invitee, the host will have to incur high cost of telephone bills and his or her own precious time. Furthermore, the host might miss out some points of the event when he or she repeats the details of the event to each invitee again and again. Instead of going through all these tedious and troublesome works, there are many other ways at present to inform the invitees that an event will be host at a particular date, time and location, for an example, sending text messages and/or email messages.

Other than sending text messages and/or email messages, some people choose to post the event's information in newspapers in order to notify the public and the invitees about the event. Posting notices in newspapers is considered a trend for people to announce the event that they wish to hold, for example, obituary notices, where a person's death are announced and a funeral service's date, time and location are stated in the obituary notice. Other than obituary notices, missing person notices are also posted in newspapers to inform the public about the occurrence and to seek help from the public to locate the missing person. Events such as product launches, birthday parties or even wedding ceremonies are posted in newspapers to inform the public about the event, and may be to invite them to the particular event.

However, there are a number of disadvantages of posting event information in newspapers, where one of the disadvantages is the incurrence of high cost. It is generally known that posting notices or advertisements on daily newspapers are costly, as the newspaper agency charges the service based on the size of the notice or advertisement, the number of days that the notice or advertisement are posted and the particular day, whether weekday or weekend, that the host wishes to post the notice or advertisement on. For example, missing person notices are normally posted for a period of time, or may be for a particular period until the missing person is found. However, the cost for posting the notice for a long period of time might be extremely high, which may not be affordable for families having middle-range household incomes. Another disadvantage is that posting the notice or advertisement in a newspaper does not guarantee that a particular person that the host wish to inform or invite will take note of the notice or advertisement in the newspaper. There might be a chance that the person is not reading the newspaper when the notice or advertisement is posted, and therefore, the person will not be informed. Furthermore, there are people who do not even read newspapers. For example, there are people who do not know that their friend or relative has deceased, as they did not notice the obituary notice in the newspaper.

As mentioned earlier, the host needs to call each and every friend and relative to inform them of the event, which is extremely tedious and troublesome. In the process, the host might also miss out some of the details that are important to let the particular friend or relative know. For example, a grieving family that is encumbered with sadness and dolefulness due to the loss of their loved one may not be able to call each and every friend and relative of the deceased person to inform them the death of the deceased person. Furthermore, calling each and every friend and relative, and telling them again and again how and when their loved one had deceased, consumes a lot of their precious time and it incurs stress and emotions that cannot be described by words.

In order to solve the above-mentioned problems, a system for event notification and information posting has been invented. The present invention provides a system that is able to send event notifications and post information on web pages to the public or anyone that the host wishes to inform. As the notifications are sent in bulk to receivers, the host does not need to inform his or her family members, friends, relatives, or colleagues one after another by calling them. The information of the event are also posted on web pages, allowing the public or any other people related to the event to view the information.

### SUMMARY OF THE PRESENT INVENTION

The present invention relates to a system for event notification and information posting that comprises a data processing means for receiving information of an event and merging the event information with a notification, a transmitting means for transmitting the notifications to receivers, a feedback processing means for receiving feedbacks from the receivers and filtering the contents of the feedbacks, a responding means for responding to the feedbacks from the receivers, an information posting means for posting and displaying the event notification and the feedbacks from the receivers at a displaying means, and a data storing means for storing the event information, the notifications, and the feedbacks from the receivers. In the system, the data processing means further comprising of a data receiving means for inputting information of the event into the system, and a data merging means for merging the event information with the notification. As for the transmitting means, it comprises a first transmitting platform for transmitting a first notification to the receiver. The transmitting means further comprises a second transmitting platform for transmitting a second notification to a communication service provider, where the second notification is delivered to the receiver through the communication service provider. Also in the system, the feedback processing means comprises a feedback receiving platform for receiving the feedbacks from the receivers, and a feedback filtering engine comprises a filtering means for filtering the contents of the feedbacks from the receivers.

It is an object of the present invention to provide a system for event notification and information posting that is able to notify friends and relatives about the information of an event.

It is another object of the present invention to provide a system for event notification and information posting that is able to notify friends and relatives about the date, time, location and any other information related to the event.

It is further an object of the present invention to provide a system for event notification and information posting that is able to remind friends and relatives about the important dates and anniversaries of the event.

It is still further an object of the present invention to provide a system for event notification and information posting that is able to receive feedbacks from receivers.

It is still further an object of the present invention to provide a system for event notification and information posting that is able to receive feedbacks regarding the receiver's attendance to the event.

It is still further an object of the present invention to provide a system for event notification and information posting that is able to post information of the event and the feedbacks onto a displaying means.

It is still further an object of the present invention to provide a system for event notification and information posting that is able to filter the feedbacks before being posted at a displaying means.

It is still further an object of the present invention to provide a system for event notification and information posting that is used for death event notifications.

It is still further an object of the present invention to provide a system for event notification and information posting that is used for missing person notifications.

It is still further an object of the present invention to provide a system for event notification and information posting that is used for birthday notifications.

It is still further an object of the present invention to provide a system for event notification and information posting that is used for product launch events.

It is still further an object of the present invention to provide a system for event notification and information posting that is used for wedding ceremony notifications.

### BRIEF DESCRIPTION OF THE DRAWINGS

FIG. 1 illustrates the system for event notification and information posting.

FIG. 2 illustrates the flow diagram for the system of the present invention.

### DETAILED DESCRIPTION OF THE PRESENT INVENTION

The above mentioned and other features and objects of this invention will become more apparent and better understood by reference to the following detailed description. It should be understood that the detailed description made known below is not intended to be exhaustive or limit the invention to the precise form disclosed as the invention may assume various alternative forms. On the contrary, the detailed description covers all the relevant modifications and alterations made to the present invention, unless the claims expressly state otherwise.

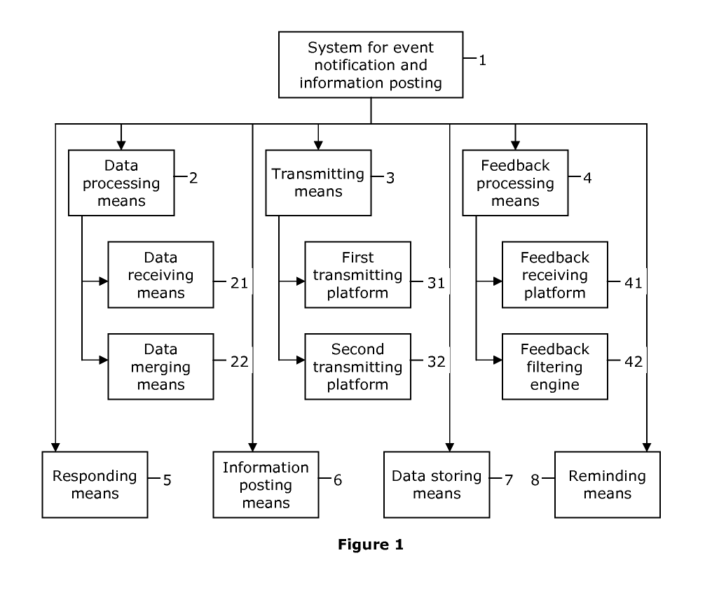

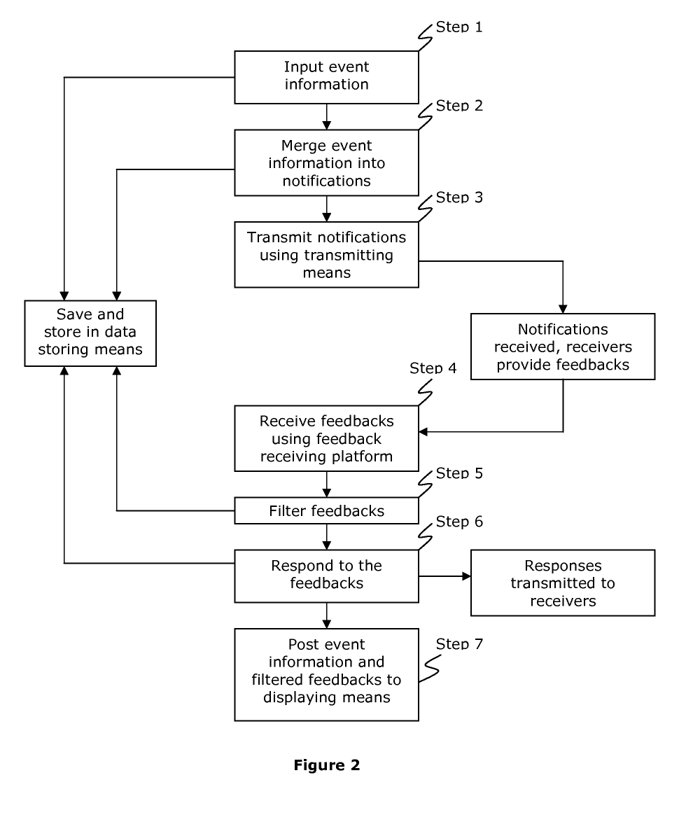

The present invention disclosed herein, as illustrated in FIGS. 1 and 2, is a novel system for event notification and information posting. The system for event notification and information posting (1) comprises a data processing means (2) for receiving information of an event and merging the event information with a notification, a transmitting means (3) for transmitting notifications to receivers, a feedback processing means (4) for receiving feedbacks from the receivers and filtering the contents of the feedbacks, a responding means (5) for responding towards the feedbacks from the receivers, an information posting means (6) for posting and displaying the event notification and feedbacks from the receivers onto a displaying means, and a data storing means (7) for storing event information, notifications, feedbacks from the receivers and responses to the receivers. In the system, the data processing means (2) further comprises a data receiving means (21) for inputting information of the event into the system, and a data merging means (22) for merging the event information with a notification. As for the transmitting means (3), it comprises a first transmitting platform (31) for transmitting first notifications to the receivers. The transmitting means (3) further comprises a second transmitting platform (32) for transmitting second notifications to a communication service provider, where the second notifications are delivered to the receivers through the communication service provider. Also in the system (1), the feedback processing means (4) comprises a feedback receiving platform (41) for receiving feedbacks from the receivers, and a feedback filtering engine (42) comprises a filtering means for filtering the contents of the feedbacks from the receivers.

As mentioned, the data processing means (2) is used to receive information of the event and to merge the event information with the notifications. The data processing means (2) comprises a data receiving means (21) for inputting information of the event into the system (1), and a data merging means (22) for merging the event information with the notifications. The information of an event mentioned herein comprises brief introduction of the event, time, date and location of the event, and an invitation to the event. After compiling the information of the event, the information is inputted into the system (1) through the data receiving means (21) (step 1). Upon inputting the information into the system (1), the information are merged with the notifications using the data merging means (22) (step 2), where the notifications mentioned herein refers to text messages of the short message services (SMS) and/or email messages. After merging the information with the notifications, the notifications may comprise a notifying message, where the message notifies the receivers of the occurrence of the event, brief introduction of the event, the date, time, and location of the event, and an invitation to the event. The event information further comprises information of the receivers, for instant, names, tele-communication numbers and email addresses of the receivers. Other information related to the receivers may also be inputted for other purposes. All information inputted into the data receiving means (21), the notifications that are merged with the event information, and the information of the receivers is subsequently stored in data storing means (7) for later use.

The notifications are delivered to the transmitting means (3) to be transmitted to the receivers (step 3). The transmitting means (3) comprises a first transmitting platform (31), where the first transmitting platform (31) transmits a first notification to the receivers. The transmitting means (3) further comprises a second transmitting platform (32), where the second transmitting platform (32) transmits a second notification to a communication service provider. While transmitting the second notifications to the communication service provider, the tele-communication numbers of the receivers are also transmitted, allowing the communication service provider to send the second notifications to the receivers. The first notifications and second notifications mentioned herein refer to the text messages of the short message service (SMS) and/or the email messages. The transmission of the tele-communication numbers of the receivers does not comprise of transmitting the names of the receivers due to security and privacy purposes. The names of the receivers are only stored in the data storing means (7) for reviewing purposes only.

As mentioned earlier, the feedback processing means (4) in the system receives feedbacks from the receivers and filters the contents of the feedbacks. Therefore, instead of being notified only by the occurrence of the event, the brief introduction of the event, the date, time, and location of the event, and the invitation to the event, the receivers are also able to provide feedbacks based on the notifications received by replying the first notification and second notification, and sending the feedbacks back to the server. The feedbacks may comprise the attendance of the receiver to the event, and the message regarding the event that the receiver wishes to express. The feedbacks are received by the feedback receiving platform (41) in the feedback processing means (4). The feedbacks replied based on the notifications that are sent out in email message, are sent directly back to the system. The feedbacks received based on the notifications that are sent as the short message services (SMS) are sent directly back to the system, by passing the communication service provider's server without leaving any traces of the feedbacks in the communication service provider's server. The feedbacks received are then filtered by the filtering means in the feedback filtering engine (42), where the contents in the feedbacks are filtered based on whether or not the content of the feedback is having the attendance of the receiver to the event only, having a message regarding the event that the receiver wishes to express only, having both the attendance and the message from the receiver, or having a message not relevant to the event. Other than this, the filtering means also filters unwanted language in the contents of the feedback. All the feedbacks received by the feedback receiving platform (41) and the filtered version of the feedbacks are saved and stored in the data storing means (7) for later use.

After receiving the feedbacks from the receivers, the responding means (5) of the system (1) responds towards the feedbacks received. Based on the messages and attendances in the feedbacks, the responding means (5) responds towards these feedbacks by preparing responses and sending the responses to the receivers, where the responses mentioned herein are gratitude expressions. Similar to what has been mentioned earlier, the responses are subsequently sent to the receivers in the form of a first notification or a second notification, depending on the type of notification the receivers have received earlier.

Subsequently, the information posting means (6) posts the event information, and the feedbacks to a displaying means, wherein the displaying means may be a web page. By posting event information and feedbacks onto the web page, the receivers will therefore be able to view the information of the event again. The information posted on the web page does not only comprise the date, time and location of the event, but also information regarding the event, which in this case the brief write out or introduction of the event. Furthermore, the messages having the expressions of the receivers that have been filtered by the feedback filtering engine (42) are also posted and displayed on the web page, so that other viewers who do not receive any first notification and second notification are able to view not only the information regarding the event, but also the messages that are expressed by the receivers.

Other than all the above-mentioned, the system (1) further comprises a reminding means (8) that is able to manage dates and anniversaries regarding the event and to remind the receivers on the dates and anniversaries of the event. As mentioned earlier, the dates inputted earlier to the data receiving means (21) are stored in the data storing means (7). The reminding means (8) keeps track of the important dates and anniversaries, and reminds the receivers that a particular date or anniversary of the event is near. Instead of only keeping track of the dates and anniversaries of the event, the reminding means (8) sends a signal to the data processing means (2) to generate reminders when the particular date or anniversary is near. Signals are sent to the data processing means (2) preferably two weeks before the date or anniversary. The reminders generated are similar to those of the notifications, where they are also sent in the form of text messages and/or email messages. However, the role played by the reminders is to remind the receivers that the particular date or anniversary of the event is near. Similar to the notifications, the reminders are also enclosed with the information regarding the event, which comprises the date, time and location of the event, and a brief text message regarding the event. The reminders generated are saved and stored in the data storing means (7) for later use. In the present invention, the reminders do not only remind the receivers the date and anniversary of the event, but also allow the receivers to provide their feedbacks on the reminders, whether or not the receivers are attending the event. The receivers may also provide feedbacks to the reminders received by sending messages back to the system (1), where the messages hereby mentioned are messages that the receivers wish to express to the event.

Like the notifications, the reminders are sent out to the receivers through the first transmitting platform (31) and the second transmitting platform (32). As mentioned earlier, if the reminders are sent out as text messages, they are transmitted together with the tele-communication numbers to the communication service provider first via the second transmitting platform (32). The communication service provider then sends the reminders out to the receivers based on the tele-communication numbers. As for the reminders that are sent out as email messages, they are sent out directly to the receivers via the first transmitting platform (31). The receivers are also allowed to provide their feedbacks based on the reminders by sending their attendances to the event or text messages relating to the event. The feedbacks from the receivers are received via the feedback receiving platform (41), which they are subsequently sent over to the feedback filtering engine (42) to filter the contents of the feedbacks. The contents in these feedbacks are filtered based on whether the contents are having attendances of the receivers to the event only, messages regarding the event that the receivers wish to express only, both the attendances and the messages, or messages that are not relevant to the event. Other than this, the feedback filtering engine (42) also filters unwanted language in the contents of the feedback. All the feedbacks received by the feedback receiving platform (41) and the filtered version of the feedbacks in this stage are saved and stored in the data storing means (7) for later use.

After filtering the feedbacks from the receivers, the responding means (5) responds to the feedbacks by sending gratitude expressions to the receivers. The gratitude expression are sent out either in the form of a first notification or a second notification, depending on the type of notification the receiver has received earlier. Subsequently, the information posting means (6) posts the anniversary of the event together with the event information and messages in the feedbacks of the receivers onto a displaying means, where the displaying means hereby refers to a web page. By doing so, family members, friends, and relatives may view the web page to obtain information of the event, and also view the messages that the family members, relatives and friends have expressed.

### Example 1

In a preferred embodiment of the present invention, the system for event notification and information posting (1) is used for death event notifications. As mentioned earlier, family members mourn with sadness and dolefulness whenever their loved one is deceased. It is difficult for them to inform friends and relatives, one after another that their loved one has passed away, especially under the sad and doleful condition. Therefore, the present invention is used to send notifications to friends and relatives of the deceased person to notify them that their loved one had passed away, and to invite them to the funeral services and religious prayers of the deceased person.

As mentioned earlier, the data receiving means (2) allows the input of event information into the system (1). In this embodiment, the event mentioned herein refers to a death event where a person had deceased. In this embodiment, the event information mentioned herein comprises the information of the deceased person, the information of the death event and the information of the receivers, where the information of the deceased person comprises the name, age, gender, date of birth, date of death, date of the funeral service, date of the memorial service, dates of the visitations and details of the family members of the deceased person, the information of the event comprises the date, time and location of the funeral service and religious prayers, and the information of the receivers comprises the names, tele-communication numbers, email addresses and relationship between the receiver and the deceased person. The information of the deceased person may further comprise biographical information and achievements of the deceased person. The receivers mentioned herein are referring to friends and relatives of the deceased person. All the information inputted into the data receiving means (21) are saved and stored in the data storing means (7) to be used in a later stage.

Upon inputting the information, the data merging means (22) then merges the information with notifications, where the notifications mentioned herein refers to text messages of the short message service (SMS) and/or the email messages. After merging the information with the notifications, the notifications may comprise notifying messages informing the receivers that a person has deceased and a funeral service will be held. Subsequently, the notifications are transmitted to the receivers via the first transmitting platform (31) and second transmitting platform (32). As mentioned earlier, the names of the receivers will not be transmitted to any other party for security and privacy issues. The names of the receivers will only be saved and stored in the data storing means (7) for reviewing purposes. After receiving the notifications, the receivers are allowed to provide feedbacks based on the notifications received. The feedbacks may be condolence messages that the receivers wish to dedicate to the family members of the deceased person. The notifications further comprise date, time and location of the funeral service and religious prayers. Based on the date, time and location, the receivers may inform the family members whether they wish to attend the funeral service and religious prayers or not by sending feedbacks to the family members. All the feedbacks are received via the feedback receiving platform (41), where the feedback receiving platform (41) subsequently sends the feedbacks to the feedback filtering engine (42) to filter the content of the feedbacks based on whether they are having condolence messages only, having attendance to the funeral service only, having both the condolence messages and the attendances to the funeral service or having messages that are not related to the deceased person. The feedback filtering engine (42) further filters unwanted language in the condolence messages, where the condolence messages having impolite or rude words, or words that are not relevant to the death event will be filtered out. All the feedbacks received from the receivers are saved and stored in the data storing means (7) for further use.

After receiving feedbacks from the receivers, family members are able to acknowledge receipt of their condolence messages and attendances to the funeral service. In this embodiment, the responding means (5) responds to the condolence messages and attendances to the funeral service by sending gratitude expressions to the receivers. As mentioned earlier, the gratitude messages are sent to the receivers via text messages and/or email messages, depending on the notifications received by the receiver earlier.

Subsequently, the obituary of the deceased person, including information of the deceased person and information of the funeral service, are posted at a web page using the information posting means (6). Other than posting the information mentioned, the feedbacks of the receivers, which in this embodiment are condolence messages, are also posted at the web page, allowing family members, friends and relatives to view the condolence messages. The posted information provides an eternal memorial service to the family members, friends and relatives.

This embodiment of the present invention further comprises a reminding means (8), where the reminding means (8) is able to manage important dates and anniversaries of the deceased person, and to remind the receivers the approaching dates and anniversaries. For example, the dates may refer to visitations, memorial services, death anniversary, birth anniversary and any other anniversaries that are related to the deceased person. When the dates or anniversaries approaches, preferably two weeks from the actual date or anniversary, the reminding means (8) sends a signal to the data merging means (22) to merge the date, information of the deceased person, information of the event, which in this case is the visitation or memorial service of the deceased person, with the reminders. The reminders mentioned herein are text messages and/or email messages. Similar to the notifications, the reminders comprise a reminding note of the important date or anniversary, information of the deceased person, information of the visitation or memorial service and also a brief text message regarding the deceased person. After merging the reminders, they are then sent out to receivers via the transmitting means (3), where the reminders are either sent out to the receivers via the first transmitting platform (31) or the second transmitting platform (32), depending on the type of notification received earlier by the receivers.

Upon receiving the reminders, the receivers are able to provide feedbacks based on the reminders. The feedbacks may comprise a condolence message that the receivers wish to dedicate to the family members, and an attendance to the memorial service of the deceased person. The feedbacks are received via the feedback receiving platform (41), where the feedbacks are then sent to the feedback filtering engine (42) to filter the content of the feedbacks to determine whether the feedbacks are having the condolence messages only, having the attendances to the memorial service, having both the condolence messages and the attendances to the memorial service or having a message not relevant to the deceased person or the obituary event. After filtering the feedbacks from the receivers, the responding means (5) of the system (1) sends gratitude messages based on the feedbacks received from the receivers. Similar to the notifications, the gratitude messages are sent to the receivers based on the type of notification and reminder received earlier. Subsequently, the information posting means (6) posts the event regarding the deceased person together with the information of the memorial service, for instance, the date, time, and location of the memorial service, and the condolence messages from the friends and relatives of the deceased person. By doing so, the family members, friends and relatives of the deceased person will not have to miss the important dates and anniversary, as the important dates and anniversaries are marked by the data processing means (2). More importantly, the family members, friends and relatives may pay their respects to the deceased person on time. The posted information provides an eternal memorial service to the family members, friends and relatives.

For the present invention, it is believed to be obvious to a person skilled in this art that the system for event notification and information posting of the present invention may be used in other application and not limited to this particular embodiment.

### Example 2

With the above example being the first and preferred embodiment, a second embodiment of the present invention is described herein, where the system for event notification and information posting (1) is used for missing person notifications. Conventionally, missing person notifications are posted in newspapers or online web pages to inform the public that a particular person is missing. However, the notice might not reach each and every person in the community, especially those who knows the missing person, as there might be people whom did not read newspapers or surf the internet. Furthermore, the cost for posting missing person notices in newspapers is extremely high, especially when one needs to continuously post the missing person notice for a long period of time. Due to the disadvantages mentioned above, the present invention is used in order to notify each and every friends and relatives of the missing person personally and post the missing person's information at a web page so that the public would take note of the missing person and provide information to the family members if necessary.

In this embodiment, the event mentioned herein refers to an event of a missing person. The event information comprises information of the missing person, information of the occurrence and information of the receivers, where the information of the missing person further comprises the name, age, gender, and appearance of the missing person when he or she is last seen, the information of the occurrence further comprises when and where the missing person is last seen, and the information of the receivers further comprises the names, tele-communication numbers, email addresses and relationships between the receivers and the missing person. Upon receiving the information mentioned herein, the information are merged with notifications using the data merging means (22). By doing so, the notifications will comprise notifying text messages that notify the receivers that a person had been missing and that help is needed in order to locate the missing person. The notifying message further comprises the name, age, gender, and appearances of the missing person in order for the receivers to have a clearer idea on who the missing person is and how the missing person looks like when he or she was last seen. The notifications mentioned herein are text messages and/or email messages

Subsequently, the notifications are transferred to the transmitting means (3), where the first notifications are transmitted to the receivers using the first transmitting platform (31) and the second notifications are transmitted to the receivers via the second transmitting platform (32). Due to security and privacy issues, the names of the receivers are not disclosed to any other parties. Therefore, only tele-communication numbers of the receivers are transmitted together with the second notifications to the communication service provider, where the second notifications are sent subsequently to the receivers based on these tele-communication numbers provided. As for the first notifications, they are sent directly to the receivers using the first transmitting platform (31) based on the email addresses that are inputted earlier. Upon receiving the notifications, the receivers are allowed to provide feedbacks. The feedbacks may comprise messages that the receivers wish to express or deliver to the family members of the missing person, or information regarding the missing person that the receivers possess and wish to provide the information to the family members in order to locate the missing person. These feedbacks are received using the feedback receiving platform (41) where the feedbacks are subsequently transferred to the feedback filtering engine (42) to filter the contents of the feedbacks. The contents of the feedbacks are filtered to determine whether the feedbacks contain thoughts or messages that the receivers wish to express to the family members or information that the receivers possess and wish to provide to the family members. The contents of the feedbacks are further filtered with the feedback filtering engine (42) to filter the unwanted language in the feedbacks. All the feedbacks received from the feedback receiving platform (41) and the feedbacks filtered from the feedbacks filtering engine (42), are saved and stored in the data storing means (7). After filtering the feedbacks, the responding means (5) acknowledges receipt of the feedbacks by sending gratitude expressions to the receivers. As mentioned previously, the gratitude messages are sent to the receivers via text messages and/or emails, depending on the notifications received by the receivers earlier.

Subsequently, the notice of the missing person, including information of the missing person and information of the occurrence, are posted at the web page using the information posting means (6). Other than posting the information mentioned, the feedbacks from the receivers, which in this embodiment are messages that the receivers wish to express and information of the missing person that the receivers wish to share, are also posted at the web page, allowing family members, friends and relatives to know whether or not anybody has seen the missing person at a predetermined period of time. If the information posted is useful, the family members will then be able to use this information to locate the missing person. Posting the missing person notice at the web page also allows the public to note that this person has been missing and that to provide the information regarding the missing person to the family members if any.

The embodiment of the present invention further comprises a reminding means (8), where the reminding means (8) is able to manage the important dates and anniversaries regarding the missing person, and to remind the receivers the approaching dates and anniversaries of the missing person. For example, the dates may refer to the birth date of the missing person or the day that the person had gone missing on. However, this may only apply to the missing persons whom are still missing and there is still a need to employ this system to notify the family members, friends, and relatives to continue searching the missing person. When the dates or anniversaries approach, preferably two weeks from the actual date, the reminding means (8) sends a signal to the data merging means (22) to merge the date and the information of the missing person to reminders, where the reminders mentioned herein are text messages and/or email messages. Similar to the notifications, the reminders comprise the reminding notes of the date that the person had gone missing, the information of the missing person, and also a brief text message regarding the missing person. After merging the reminders, the reminders are then sent out to receivers using the transmitting means (3), wherein the reminders are either sent out to the receiver by the first transmitting platform (31) or the second transmitting platform (32), depending on the type of notification received earlier by the receivers.

Upon receiving the reminders, the receivers are able to provide feedbacks based on the reminders. The feedbacks may comprise the information regarding the missing person that the receivers wish to provide to the family members or the messages that the receivers wish to express to the family members. These feedbacks are received using the feedback receiving platform (41), where the feedbacks are then sent to the feedback filtering engine (42) to filter the content of the feedback to determine whether the feedback is having the information regarding the missing person, the message that the receivers wish to express, both the information regarding the missing person and the message that the receivers wish to express, or information and messages not related to the missing person.

After filtering the feedbacks from the receivers, the responding means (5) of the system (1) sends the gratitude messages based on the feedbacks received from the receivers. Similar to the notifications, the gratitude messages are sent to receivers based on the type of notifications and reminders received earlier. Subsequently, the information posting means (6) posts the missing person notice together with the information of the missing person, and the messages feedback from the receivers at the web page. By doing so, the family members, friends and relatives of the missing person will have more chance to know where to locate the missing person. Furthermore, the notification posted at the web page also allows the public to take note of the missing person, try to locate the missing person or provide any information regarding the missing person to the family members. The notifications and reminders may be sent to the receivers, as many times as required.

For the present invention, it is believed to be obvious to the person skilled in this art that the system for event notification and information posting (1) of the present invention may be used in other application and not limited to this particular embodiment.

### Example 3

In a third embodiment of the present invention, the system for event notification and information posting (1) is used for birthday notifications. Birthday celebrations are among the happiest celebrations among all the celebrations, as this celebration is to celebrate the birth of an individual. At present, many people love celebrating their own birthdays in parties or events together with their family members, friends, relatives and colleagues. If the amount of people that one desires to invite is large, it is quite impossible for the person hosting the birthday celebration to call and inform each and everyone in the list of invitees. Even worst, they might miss out some details of the birthday celebration when calling and informing them about the birthday celebration. Therefore, the present invention is used, in order to notify each and every invitee where and when the birthday celebration will be held.

In this embodiment, the event mentioned herein refers to a birthday celebration. The event information comprises information of the person celebrating his or her birthday, information of the birthday celebration and information of the receivers, where the receivers hereby refer to the invitees that are invited to the birthday celebration. In this embodiment, the information of the person celebrating his or her birthday further comprises the name, age and gender of the person, whereby the information of the birthday celebration comprises when and where the birthday celebration will be held, and the information of the invitees comprises the names, tele-communication numbers, email addresses and relationship between the invitee and the birthday person. The information of the person celebrating his or her birthday may further comprise his or her biographical information and achievements. All the information mentioned herein is inputted to the system using the data receiving means (21). Upon receiving the information mentioned herein, the information are merged with the notifications using the data merging means (22). By doing so, the notifications will consist notifying text message that notifies the invitees about the birthday celebration. The notifying message will comprise the name, age, and gender of the birthday person, the information on where and when the birthday celebration will be held. The notifications mentioned herein are the text messages and/or email messages

Subsequently, the notifications are transferred to the transmitting means (3), where the first notifications are transmitted to the receivers using the first transmitting platform (31) and the second notifications are transmitted to the receivers using the second transmitting platform (32). Due to security and privacy issues, the names of the invitees are not disclosed to any other party. Therefore, only the tele-communication numbers of the invitees are transmitted together with the second notifications to the communication service provider, where the second notifications are sent subsequently to the invitees based on these tele-communication numbers provided. Upon receiving the notifications, the invitees are allowed to provide feedbacks. The feedbacks may comprise birthday messages that the invitees wish to express or deliver to the birthday person, or the attendance of the invitees to the birthday celebration. These feedbacks are received via the feedback receiving platform (41) where the feedbacks are subsequently transferred to the feedback filtering engine (42) to filter the contents of the feedbacks. The contents of the feedbacks are filtered to determine whether the feedbacks comprise the birthday messages that the invitees wish to express to the birthday person, or the attendance of the invitees to the birthday celebration. The contents of the feedbacks are further filtered with the feedback filtering engine (42) to filter unwanted language in the feedbacks. All the feedbacks received from the feedback receiving platform (41) and the feedbacks filtered from the feedbacks filtering engine (42), are saved and stored in the data storing means (7). After filtering the feedbacks, the responding means (5) then acknowledges receipt of the feedbacks by sending gratitude expressions to the invitees. As mentioned previously, the gratitude messages are sent to the invitees in text messages and/or email messages, depending on the notifications received by the invitees earlier.

Subsequently, the notice of the birthday celebration, including the information of the birthday person, and the information of the birthday celebration, are posted at the web page using the information posting means (6). Other than posting the information mentioned, the feedbacks from the invitees, which in this embodiment are birthday messages that the invitees wish to express, are also posted at the web page, allowing family members, friends and relatives to obtain information of the birthday celebration and to share the happiness together.

The embodiment of the present invention further comprises a reminding means (8), wherein the reminding means (8) is able to manage birth dates of a person, and to remind the invitees the approaching birth date. When the birth date is approaching, preferably two weeks from the actual date, the reminding means (8) sends a signal to the data merging means (22) to merge the birth date of the birthday person and the information of the birthday celebration with the reminders, wherein the reminders mentioned are text messages and/or email messages. Similar to the notifications, the reminders comprise the reminding notes of the birth date, the information and also the brief text message regarding the birthday person. After merging the reminders, they are then sent out to the invitees using the transmitting means (3), where the reminders are either sent out to the invitees by the first transmitting platform (31) or the second transmitting platform (32), depending on the type of notification received earlier by the invitees.

Upon receiving the reminders, the invitees are able to feedback based on the reminders. The feedbacks may comprise birthday messages that the invitees wish to dedicate to the birthday person, or the attendance to the birthday celebration. These feedbacks are received via the feedback receiving platform (41), where the feedbacks are then sent to the feedback filtering engine (42) to filter the content of the feedback to determine whether the feedback is having the birthday messages that the invitees wish to dedicate to the birthday person, the attendance to the birthday celebration, both the birthday messages that the invitees wish to dedicate to the birthday boy or girl and the attendance to the birthday celebration, or the messages not related to the birthday person.

After filtering the feedbacks from the invitees, the responding means (5) of the system (1) sends the gratitude messages based on the feedbacks received from the invitees. Similar to the notifications, the gratitude messages are sent to the invitees based on the type of notifications and reminders received earlier. Subsequently, the information posting means (6) posts the birthday celebration, and the information regarding the birthday person, and the date, time, and location of the birthday celebration at a web page. By doing so, the family members, friends, relatives, colleagues and invites will have the chance to view the information of the birthday celebration and also share the happiness together, as the birthday messages to the birthday person are also posted at the web page.

For the present invention, it is believed to be obvious to the person skilled in this art that the system for event notification and information posting (1) of the present invention may be used in other application and not limited to this particular embodiment.

### Example 4

In a fourth embodiment of the present invention, the system for event notification and information posting (1) is used for product launch events. For each company, events for launching new products are considered very important events for the company as the events determine whether or not the new product has been fully introduced to the buyers and subsequently determines the sales figures of the company. It depends on each company on where, when and how many people that the company wishes to invite. For some companies with smaller budgets, they will only be able to host launching events that are moderate in size. They might not even have that much of budget to post the event on newspapers for a number of days, due to the fact that posting advertisements on newspapers incurs extremely high cost, especially when they need to post the advertisement for a long period of time. Advertisement posted on the newspapers informing the public about the launch of the new product comprises inviting people whom do not attend the event. For this reason, it is a must for the company to send out the invitations to the invitees to attend the launch of the new product. Therefore, the system for event notification and information posting (1) of the present invention is used in order to overcome the above-mentioned problems.

In this embodiment, the event mentioned herein refers to a product launch event. The event information comprises the information of the company that is launching the new product, information of the new product, information of the product launch event and information of the receivers, where the receivers hereby refer to the invitees who are invited to the product launch event. In this embodiment, the information of the company that is launching the new product further comprises the name and general information of the company, whereby the information of the new product comprises description of the new product, and the information of the product launch event comprises where and when the event is going to be held. As for the information of the invitees, it comprises the names, tele-communication numbers, email addresses, company's name and designation of the invitee in the company. All the information mentioned herein is inputted to the system (1) using the data receiving means (21). Upon receiving the information mentioned herein, the information is merged with the notifications using the data merging means (22). By doing so, the notifications may comprise the notifying text message that notifies the invitees on the product launch event. The notifying message also comprises the name and general information of the company, the description of the new product, and where and when the event is going to be held. The notifications mentioned herein are text messages and/or email messages.

Subsequently, the notifications are transferred to the transmitting means (3), where the first notifications are transmitted to the invitees via the first transmitting platform (31) and the second notifications are transmitted to the invitees via the second transmitting platform (32). Due to security and privacy issues, the details of the invitees are not disclosed to any other parties. Therefore, only the tele-communication numbers of the invitees are transmitted together with the second notifications to the communication service provider, where the second notifications are sent subsequently to the invitees based on these tele-communication numbers provided. As for the first notifications, they are sent out directly via the first transmitting platform (31) based on the email addresses that are inputted earlier. Upon receiving the notifications, the invitees are allowed to provide feedbacks. The feedbacks may comprise the messages that the invitees wish to express to the company, for example, congratulating messages, or attendance of the invitees to the product launch event. These feedbacks are received via the feedback receiving platform (41) where the feedbacks are subsequently transferred to the feedback filtering engine (42) to filter the contents of the feedbacks. The contents of the feedbacks are filtered to determine whether the feedbacks comprise the congratulating messages that the invitees wish to express to the company, or the attendances of the invitees to the product launch event. The contents of the feedbacks are further filtered with the feedback filtering means to filter unwanted language in the feedbacks. All the feedbacks received from the feedback receiving platform (41) and the feedbacks filtered from the feedbacks filtering engine (42), are saved and stored in the data storing means (7).

After filtering the feedbacks, the responding means (5) then acknowledges receipt of the feedbacks by sending gratitude expressions to the invitees. As mentioned previously, the gratitude messages are sent to the invitees via text messages and/or email messages, depending on the notifications received by the invitees earlier. Subsequently, the notice of the product launch event, together with the information of the company, and the new product are posted at the web page using the information posting means (6). Other than posting the information mentioned, the feedbacks from the invitees, which in this embodiment are the congratulating messages the invitees wish to dedicate to the company are also posted at the web page, allowing the public, the invitees and the employees of the company to view the information of the product launch event.

The embodiment of the present invention further comprises a reminding means (8), wherein the reminding means (8) is able to manage the important dates of the product launch event, for example, the dates of the second or third launch events. Furthermore, the reminding means (8) is able to remind the invitees the date of the subsequent product launch event is approaching. When the date approaches, preferably two weeks from the actual date, the reminding means (8) sends a signal to the data merging means (22) to merge the launching date, the information of the company, the information of the new product and the information of the product launch event with the reminders, wherein the reminders mentioned herein are the text messages and/or the email messages. Similar to the notifications, the reminders contain reminding notes of the launching date, text messages that describe the company and the new product, and where and when the product launch event is going to be held. After merging the reminders, they are then sent out to invitees via the transmitting means (3), where the reminders are either sent out to the invitees via the first transmitting platform (31) or the second transmitting platform (32), depending on the type of notification received earlier by the invitees.

Upon receiving the reminders, the invitees are able to provide feedbacks. The feedbacks may comprise the congratulating messages that the invitees wish to dedicate to the company, or the attendance to the product launch event. These feedbacks are received via the feedback receiving platform (41), where the feedbacks are then sent to the feedback filtering engine (42) to filter the content of the feedback to determine whether the feedback is having the congratulating messages that the invitees wish to dedicate to the company, the attendance to the product launch event, both the congratulating messages and the attendance to the product launch event, or the messages that are not related to the product launch event.

After filtering the feedbacks from the invitees, the responding means (5) of the system sends the gratitude messages based on the feedbacks received from the invitees. Similar to the notifications, the gratitude messages are sent to invitees based on the type of notifications and reminders received earlier. Subsequently, the information posting means (6) posts the product launch event, together with the information of the company, the information of the new product, the date, time and location of the product launch event, at the web page. By doing so, the invitees, public and employees of the company will then be able to view the information of the product launch event and the congratulating messages.

For the present invention, it is believed to be obvious to the person skilled in this art that the system for event notification and information posting of the present invention may be used in other application and not limited to this particular embodiment.

### Example 5

In a fifth embodiment of the present invention, the system for event notification and information posting (1) is used for wedding ceremony notifications. Upon confirming the date, time and location for a wedding ceremony, a couple would need to announce the joyous and meaningful event to their relatives and friends. Conventionally, the couples would have to call each and every relative and friend to notify them about the wedding ceremony. However, it consumes a lot of time and efforts for the couple to call each and every relative and friend, especially when the couple has many relatives and friends. Furthermore, the couple might not know well the relatives or friends that they are calling, due to the fact that they have not met them for a period of time, which causes awkwardness during the conversations on the phone. Some couples choose to announce their wedding through newspaper notifications. However, the notifications might not reach each and every relative and friend as there might be a chance that a relative or a friend whom does not read newspaper. Moreover, the cost incurred for posting notification on newspaper is high, which might not be affordable for some couples. For the above disadvantages mentioned, it is therefore a need for the couples to employ the system for event notification and information posting of the present invention, in order to announce their wedding ceremony and also to invite their relatives and friends to the wedding ceremony.

The event, mentioned in this embodiment, refers to a wedding ceremony. The event information comprises information of the wedding ceremony, information of the couple hosting the wedding ceremony and information of the receivers, where the receivers hereby refers to invitees that are invited to the wedding ceremony. The information of the wedding ceremony hereby comprises the date, time and location of the wedding ceremony, whereby the information of the couple hereby comprises a brief introduction of the couple, which comprises their names and general introduction about their marriage. The information of the invitees comprises the names, tele-communication numbers, email addresses, and relationship between the invitees and the couple. All the information mentioned herein is inputted to the system (1) using the data receiving means (21). Upon receiving the information mentioned herein, the information is merged with the notifications using the data merging means (22). By doing so, the notifications may comprise the notifying text message that notifies the invitees about the wedding ceremony. The notifying message also comprises the name of the couple, general introduction of their marriage, where and when the wedding ceremony is going to be held, and an invitation to invite the invitees to the wedding ceremony. The notifications mentioned herein refer to the text messages and/or email messages.

Subsequently, the notifications are transferred to the transmitting means (3), where the first notifications are transmitted to the invitees via the first transmitting platform (31) and the second notifications are transmitted to the invitees via the second transmitting platform (32). Due to security and privacy issues, the details of the invitees are not disclosed to any other parties. Therefore, only the tele-communication numbers of the invitees are transmitted together with the second notifications to the communication service provider, where the second notifications are sent subsequently to the invitees based on these tele-communication numbers provided. As for the first notifications, they are sent out directly via the first transmitting platform (31) based on the email addresses that are inputted earlier. Upon receiving the notifications, the invitees are allowed to provide feedbacks. The feedbacks may comprise the congratulating messages that the invitees wish to express to the couple, or the attendance of the invitees to the wedding ceremony. The invitees may further include the number of people in his or her family that are attending the wedding ceremony, so that the couple could make arrangement for their guests before the wedding ceremony starts. These feedbacks are received via the feedback receiving platform (41) where the feedbacks are subsequently transferred to the feedback filtering engine (42) to filter the contents of the feedbacks. The contents of the feedbacks are filtered to determine whether the feedbacks comprise the congratulating messages that the invitees wish to express to the couple, or the attendance of the invitees to the wedding ceremony. The contents of the feedbacks are further filtered with the feedback filtering engine to screen unwanted language in the feedbacks. All the feedbacks received from the feedback receiving platform (41) and the feedbacks filtered from the feedbacks filtering engine (42), are saved and stored in the data storing means (7).

After filtering the feedbacks, the responding means (5) then acknowledges receipt of the feedbacks by sending the gratitude expressions to the invitees. Similar to what have been mentioned earlier, the gratitude messages are sent to the invitees in text messages and/or email messages, depending on the notifications received by the invitees earlier.

Subsequently, the notice of the wedding ceremony, together with the information of the wedding ceremony and the information of the couple are posted at the web page using the information posting means (6). Other than posting the information mentioned, the feedbacks from the invitees, which in this embodiment are the congratulating messages that the invitees wish to dedicate to the couple are also posted at the web page. By posting the notice, information and congratulating messages at the web page, the public and the invitees will be able to view at anytime the notice and the information of the wedding ceremony, and also to share the happiness with the couple.

The embodiment of the present invention further comprises a reminding means (8), where the reminding means (8) is able to manage the important dates of the wedding ceremony, for example the dates of the first and subsequent wedding anniversaries. Furthermore, the reminding means (8) is able to remind the invitees the approaching dates of the wedding anniversaries. If the couple wishes to organize an event to celebrate their wedding anniversary, the reminding means (8) will be employed. When the date approaches, preferably two weeks from the actual date of the wedding anniversary, the reminding means (8) sends a signal to the data merging means (22) to merge the date of the wedding anniversary celebration, the information of the wedding anniversary celebration and the information of the couple with the reminders, where the reminders mentioned herein are the text messages or the email messages. Similar to the notifications, the reminders comprise the reminding notes to remind invitees that the wedding anniversary of the couple is approaching, the text messages that briefly describe the couple's marriage, where and when the wedding anniversary will be held, and the invitation to invite the invitees to the wedding anniversary celebration. After merging the reminders, they are then sent out to the invitees via the transmitting means (3), where the reminders are either sent out to the invitees via the first transmitting platform (31) or the second transmitting platform (32), depending on the type of notification received earlier by the invitees.

Upon receiving the reminders, the invitees are able to provide feedbacks. The feedbacks may comprise the congratulating messages that the invitees wish to dedicate to the couple, or the attendances to the wedding anniversary celebration. These feedbacks are received via the feedback receiving platform (41), where the feedbacks are then sent to the feedback filtering engine (42) to filter the contents of the feedbacks to determine whether the feedbacks comprise the congratulating messages that the invitees wish to dedicate to the couple, the attendances to the wedding anniversary celebration, both the congratulating messages and the attendances to the wedding anniversary celebration, or the messages that are not related to the wedding anniversary or the couple.

After filtering the feedbacks from the invitees, the responding means (5) of the system (1) sends the gratitude messages to the invitees. Similar to the notifications, the gratitude messages are sent to the invitees based on the type of notification and reminder received earlier. Subsequently, the information posting means (6) posts the wedding anniversary together with the text messages that briefly describe the couple's marriage, the date, time and location of the wedding anniversary celebration, and the congratulating messages from the invitees at the web page. By having the information posted at the web page, the invitees will be able to view the information of the wedding anniversary celebration at anytime that they prefer. As the congratulating messages are also posted at the web page, the couple, together with the invitees will be able to share the happiness among each other.

For the present invention, it is believed to be obvious to the person skilled in this art that the system for event notification and information posting of the present invention may be used in other application and not limited to this particular embodiment.

I/We claim:

1. A system for event notification and information posting (1) comprises:
a data processing means (2) for receiving information of an event and merging the event information with a notification;
a transmitting means (3) for transmitting the notification to a receiver;
a feedback processing means (4) for receiving a feedback from the receiver and filtering the contents of the feedback;
a responding means (5) for responding to the feedback from the receiver;
an information posting means (6) for posting and displaying the event notification and the feedback from the receiver at a displaying means; and
a data storing means (7) for storing the event information, the notification, the feedback from the receiver and responds to the receivers.

2. A system (1) in accordance with claim 1, wherein the data processing means (2) further comprises of:
a data receiving means (21) for inputting information of the event into the system (1); and
a data merging means (22) for merging the event information with a notification;

3. A system (1) in accordance with claim 1, wherein the notifications are text messages, either in short message services (SMS), email messages, or in combination of both.

4. A system (1) in accordance with claim 1, wherein the transmitting means (3) comprises a first transmitting platform (31) for transmitting a first notification to the receiver.

5. A system (1) in accordance with claims 1, 3 and 4, wherein the transmitting means (3) further comprises a second transmitting platform (32) for transmitting a second notification to a communication service provider, where the second notification is delivered to the receiver through the communication service provider.

6. A system (1) in accordance with claims 3 and 4, wherein the first notification is an email message.

7. A system (1) in accordance with claims 3 and 5, wherein the second notification is a text message in short message service (SMS).

8. A system (1) in accordance with claims 3, 6 and 7, wherein the first notification and the second notification comprise a text message notifying the receiver an occurrence of the event, a brief introduction of the event, the date, time, and location of the event, and an invitation to the event.

9. A system (1) in accordance with claim 1, wherein the feedback processing means (4) comprises of:
a feedback receiving platform (41) for receiving the feedbacks from the receivers; and
a feedback filtering engine (42) comprises a filtering means for filtering the contents of the feedbacks from the receivers;

10. A system (1) in accordance with claim 1, wherein the event information comprises a brief introduction of the event, where and when the event be held and an invitation to the event.

11. A system (1) in accordance with claims 1 and 10, wherein the event information further comprises the information of the receivers.

12. A system (1) in accordance with claim 11, wherein the information of the receivers comprises the names, tele-communication numbers and email addresses of the receivers.

13. A system (1) in accordance with claim 1, wherein the feedbacks comprise the attendance of the receivers to the event, and the message that the receivers wish to express.

14. A system (1) in accordance with claims 1 and 9, wherein the filtering means filters the feedbacks based on whether or not the contents of the feedbacks comprise the attendance of the receivers to the event, the messages that the receivers wish to express, both the attendance and the messages from the receivers, or the message that are not relevant to the event.

15. A system (1) in accordance with claim 14, wherein the filtering means further comprises filtering unwanted language in the contents of the feedbacks.

16. A system (1) in accordance with claim 1, wherein the responding means (5) responds to the feedbacks from the receivers by preparing responds and sending the responds to the receivers, where the responds are the gratitude expressions.

17. A system (1) in accordance with claim 1, wherein the system (1) further comprises a reminding means (8) for managing dates and anniversaries regarding the event and for reminding the receivers the dates and anniversaries of the event.

18. A system (1) in accordance with claim 17, wherein the reminding means (8) sends a signal to the data merging means (22) to merge the dates, anniversaries, and the event information with a first reminder and a second reminder.

19. A system (1) in accordance with claim 1, wherein the displaying means is a web page.

20. A system in accordance with claim 1, wherein the event is a death event.

21. A system (1) in accordance with claims 1 and 20, wherein the event information comprises the information of a deceased person, the information of the death event, and the information of receivers.

22. A system (1) in accordance with claim 21, wherein the information of the deceased person comprises the name, age, gender, date of birth, date of death, and details of the family members of the deceased person.

23. A system (1) in accordance with claims 21, and 22, wherein the information of the deceased person further comprises the biographical information and the achievements of the deceased person.

24. A system (1) in accordance with claim 21, wherein the information of the death event comprises the date, time and location of the funeral service and religious prayers of the deceased person.

25. A system (1) in accordance with claim 21, wherein the information of the receivers comprises the names, tele-communication numbers, email addresses and relationship between the receiver and the deceased person.

26. A system (1) in accordance with claims 21 and 25 wherein the receivers are the friends and relatives of the deceased person.

27. A system (1) in accordance with claims 1 and 20, wherein the first notification and the second notification comprise the text messages notifying the receivers the obituary and inviting the receivers to the funeral service of the deceased person.

28. A system (1) in accordance with claims 1 and 20, wherein the feedbacks are the condolence messages and the attendance to the funeral service.

29. A system (1) in accordance with claims 1 and 20, wherein the filtering means filters the contents based on whether or not the contents of the feedbacks comprise the condolence messages, the attendance to the funeral service, both the condolence messages and the attendance to the funeral service, or the messages that are not related to the funeral service or the deceased person.

30. A system (1) in accordance with claims 1 and 20, wherein the filtering means further comprises filtering unwanted language in the contents of the feedbacks.

31. A system (1) in accordance with claims 1 and 20, wherein the system further comprises a reminding means (8) for managing the date and anniversaries of the death event and reminding the receivers the dates and anniversaries of the death event.

32. A system (1) in accordance with claim 31, wherein the date and anniversaries comprises the visitation dates, memorial service dates, birth dates, death dates and anniversaries related to the deceased person

33. A system (1) in accordance with claim 1, is used for missing person notifications to send the notifications about the missing person to the receivers and post the information about the missing person at the displaying means.

34. A system (1) in accordance with claim 1, is used for birthday celebration notifications to send the notifications about the birthday celebration to the receivers and post the information about the birthday celebration at the displaying means.

35. A system (1) in accordance with claim 1, is used for product launch event to send the notifications about the product launch event to the receivers and post the information about the product launch event at the displaying means.

36. A system (1) in accordance with claim 1, is used for a wedding ceremony notifications to send the notifications about the wedding ceremony to the receivers and post the information about the wedding ceremony at the displaying means.

37. A method of using the system for event notification and information posting (1) comprises the steps of:
inputting the information of an event into the system (1) using the data receiving means (21) (step 1);
merging the event information with the first notification and second notification using the data merging means (22) (step 2);
transmitting the first notification to the receivers and simultaneously transmitting the second notification to the communication service provider, wherein the second notifications are further transmitted to the receivers from the communication service provider (step 3);
receiving the feedbacks of the first notifications and second notification using the feedback receiving platform (41) (step 4);
filtering contents of the feedbacks using the feedback filtering engine (42) (step 5);
responding towards the feedbacks received by sending gratitude messages using the responding means (5) (step 6); and
posting the information of the event and filtered the feedbacks at a displaying means using the information posting means (6) (step 7).

38. A method in accordance with claim 37, wherein the event is a death event.

39. A method in accordance with claims 37 and 38, wherein the event information comprises the information of a deceased person, information of the death event, and the information of the receivers.

40. A method in accordance with claims 37, 38 and 39, wherein the information of the deceased person comprises the name, age, gender, date of birth, date of death, and details of the family members of the deceased person.

41. A method in accordance with claims 37, 38, 39 and 40, wherein the information of the deceased person further comprises the biographical information and the achievements of the deceased person.

42. A method in accordance with claims 37, 38 and 39, wherein the information of the death event comprises the date, time and location of the funeral service of the deceased person.

43. A method in accordance with claims 37, 38 and 39, wherein the receivers are the friends and relatives of the deceased person.

44. A method in accordance with claims 37, 38, 39 and 43, wherein the information of the receivers comprises the names, tele-communication numbers, email addresses and relationship between the receiver and the deceased person.

45. A method in accordance with claims 37 and 38, wherein the first notification and second notification comprise the text messages notifying the receivers the obituary and inviting the receivers to the funeral service of the deceased person.

46. A method in accordance with claims 37 and 38, wherein the feedbacks are the condolence messages and the attendance to the funeral service.

47. A method in accordance with claims 37 and 38, wherein the filtering means filters the contents of the feedback in terms of having the condolence messages only, having the attendance to the funeral service only, having both the condolence messages and the attendance to the funeral service, and having feedbacks not related to the condolence messages and the attendance to the funeral service.

48. A method in accordance with claims 37 and 38, wherein the filtering means further filters the unwanted language in the contents of the feedbacks.

49. A method in accordance with claims 37 and 38, wherein the method further comprises managing the date and anniversary of the event and reminding the receivers the date and anniversary of the event, by using the reminding means (8).

50. A method in accordance with claims 37, 38 and 49, wherein the date and anniversaries comprises the visitation dates, memorial service dates, birth dates, death dates and anniversaries related to the deceased person.

51. A method in accordance with claim 37, wherein the displaying means is a web page.

52. A method in accordance with claim 37, is used for missing person notifications to send the notifications about the missing person to the receivers and post the information about the missing person at the displaying means.

53. A method in accordance with claim 37, is used for birthday celebration notifications to send the notifications about the birthday celebration to the receivers and post the information about the birthday celebration at the displaying means.

54. A method in accordance with claim 37, is used for product launch event to send the notifications about the product launch event to the receivers and post the information about the product launch event at the displaying means.

55. A method in accordance with claim 37, is used for wedding ceremony notifications to send the notifications about the wedding ceremony to the receivers and post the information about the wedding ceremony at the displaying means.
